(19) United States
(12) Patent Application Publication
(10) Pub. No.: US 2017/0069904 A1
(43) Pub. Date: Mar. 9, 2017

(54) SEPARATOR FOR BATTERY, SECONDARY BATTERY INCLUDING THE SAME, AND METHOD OF MANUFACTURING SEPARATOR FOR BATTERY

(71) Applicant: TOYOTA JIDOSHA KABUSHIKI KAISHA, Toyota-shi (JP)

(72) Inventors: Yuya ISHIHARA, Miyoshi-shi (JP); Kazuhisa TAKEDA, Toyota-shi (JP); Akihiro OCHIAI, Nissin-shi (JP)

(73) Assignee: TOYOTA JIDOSHA KABUSHIKI KAISHA, Toyota-shi (JP)

(21) Appl. No.: 15/259,678

(22) Filed: Sep. 8, 2016

(30) Foreign Application Priority Data
Sep. 9, 2015 (JP) 2015-177776

(51) Int. Cl. H01M 2/34; H01M 2/16; H01M 2/14

(52) U.S. Cl. CPC H01M 2/348; H01M 2/145; H01M 2/166; H01M 2200/10

(57) ABSTRACT

In a separator for a battery in which a porous film formed of a polyolefin resin is used as a substrate, the substrate has a melting point lower than 150° C. The separator includes porous heat resistance layers that are disposed on front and back surfaces of the substrate and on opposite end portions of the substrate in a width direction and that include inorganic filler particles and a binder. Further, a thickness of each of the porous heat resistance layers disposed on the opposite end portions of the substrate in the width direction is in a range of 5 to 5000 μm and is equal to or more than the sum of thicknesses of the porous heat resistance layers disposed on the front and back surfaces of the substrate.

### INCORPORATION BY REFERENCE

The disclosure of Japanese Patent Application No. 2015-177776 filed on Sep. 9, 2015 including the specification, drawings and abstract is incorporated herein by reference in its entirety.

### BACKGROUND

1. Technical Field

The present disclosure relates to a separator which is disposed between a positive electrode and a negative electrode in a battery, a secondary battery including the separator, and a method of manufacturing a separator for a battery.

2. Description of Related Art

Batteries such as secondary batteries include, as an internal structure, an electrode body in which a positive electrode and a negative electrode are disposed adjacent to each other in an electrolytic solution. In this electrode body, it is necessary to dispose the positive electrode and the negative electrode such that they can exchange ions through the electrolytic solution without direct contact therebetween. Therefore, a separator for a battery is disposed between the positive electrode and the negative electrode. As the separator for a battery, in many cases, a porous film formed of an insulating material such as a thermoplastic resin is used.

A separator for a battery which is a porous film formed of a thermoplastic resin has a shutdown function of blocking pores by melting during a temperature increase to interrupt an ion flow path between the positive and negative electrodes. Examples of the separator for a battery include a separator disclosed in Japanese Patent Application Publication No. 2012-49052 (JP 2012-49052 A). The separator disclosed in JP 2012-49052 A has a structure in which a porous heat resistance layer is disposed on a surface of a substrate which is a porous resin film. The disposition of the porous heat resistance layer prevents further shrinkage of the substrate after shutdown. When the temperature further increases after shutdown, a substrate which is a thermoplastic resin further shrinks. As a result, short-circuiting may occur between a positive electrode and a negative electrode.

### SUMMARY

Recently, in order to obtain a more reliable shutdown function, it has been required for a base resin of a separator to have a lower melting point. In a thermoplastic resin having a low melting point, a strong shrinkage force is likely to be generated during a temperature increase. Therefore, even when this porous heat resistance layer is disposed as disclosed in JP 2012-49052 A, shrinkage of the porous heat resistance layer cannot be completely prevented during a temperature increase, which may cause short-circuiting between the positive electrode and the negative electrode.

The present disclosure provides a separator for a battery including a substrate which is a porous film having a relatively low melting point, in which the substrate has satisfactory shrinkage resistance after shutdown.

According to a first aspect of the present disclosure, there is provided separator for a battery including: a substrate that is a porous film formed of a polyolefin resin and has a melting point lower than 150° C.; and porous heat resistance layers that are disposed on front and back surfaces of the substrate and on opposite end portions of the substrate in a width direction and include inorganic filler particles and a binder. In the first aspect of the present disclosure, a thickness of each of the porous heat resistance layers disposed on the opposite end portions of the substrate in the width direction is in a range of 5 to 5000 μm and is equal to or more than a sum of thicknesses of the porous heat resistance layers disposed on the front and back surfaces of the substrate.

According to the first aspect of the present disclosure, when seen in a sectional view in a width direction, all of the four sides of the substrate are supported by the porous heat resistance layers. In particular, the porous heat resistance layers disposed on the opposite end portions of the substrate in the width direction have a sufficient thickness. Therefore, even in a state where the resin of the substrate is melted during a temperature increase, the porous heat resistance layers prevent shrinkage of the substrate. Thus, the shutdown function of the separator for a battery is exhibited without deteriorating due to the shrinkage of the base resin. As a result, the separator for a battery exhibits satisfactory shutdown characteristics even when the resin having a relatively low melting point is used as a substrate.

According to a second aspect of the present disclosure, there is provided a secondary battery including: a positive electrode sheet; a negative electrode sheet; and the separator according to the first aspect that is laminated together with the positive electrode sheet and the negative electrode sheet.

According to a third aspect of the present disclosure, there is provided a method of manufacturing a separator for a battery, the method including: forming a slurry layers by applying a slurry including inorganic filler particles and a binder to front and back surfaces of a substrate and to opposite end portions of the substrate in a width direction, the substrate being a porous film formed of a polyolefin resin and having a melting point lower than 150° C.; adjusting thicknesses of the slurry layers applied to the front and back surfaces of the substrate and to the opposite end portions of the substrate in the width direction such that, when measured after drying, a thickness of each of the slurry layers disposed on the opposite end portions of the substrate in the width direction is in a range of 5 to 5000 μm and is equal to or more than a sum of thicknesses of the slurry layers disposed on the front and back surfaces of the substrate; and drying the slurry layers whose thicknesses are adjusted.

According to the above-described configuration, a separator for a battery including a substrate which is a porous film having a relatively low melting point can be provided, in which the substrate has satisfactory shrinkage resistance after shutdown.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a sectional view showing a separator for a battery according to an embodiment;

FIG. 2 is a front view showing an apparatus which manufactures the separator for a battery according to the embodiment;

FIG. 3 is a plan view showing a gap member;

FIG. 4 is a sectional view showing adjustment of the thickness of each of slurry layers using the gap member;

FIG. 5 is a sectional view showing a schematic structure of a battery;

FIG. 6 is a sectional view showing shrinkage of a separator of the related art during a temperature increase;

FIG. 7 is a sectional view showing a state of the separator for a battery according to the embodiment during shutdown;

FIG. 8 is a sectional view showing a state where the temperature of the separator for a battery according to the embodiment is increased after shutdown;

FIG. 9 is a graph showing a relationship between a melting point of a porous resin used as a substrate and a width-direction size retention ratio during shrinkage after shutdown; and

FIG. 10 is a graph showing a relationship between a thickness of an end portion of a heat resistance layer and a width-direction size retention ratio during shrinkage after shutdown.

### DETAILED DESCRIPTION OF EMBODIMENTS

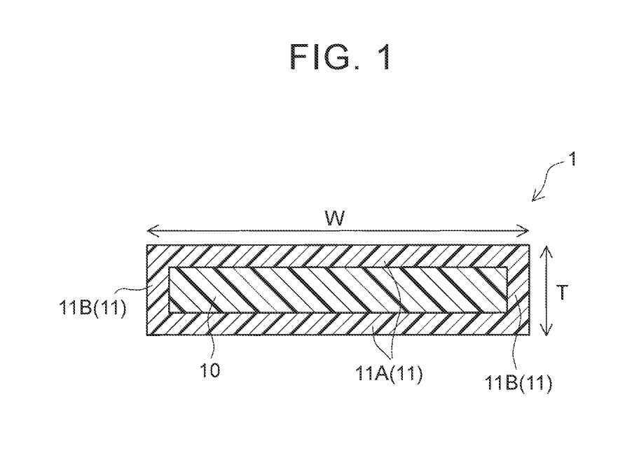

Hereinafter, an embodiment of the present disclosure will be described in detail with reference to the accompanying drawings. A separator 1 for a battery according to the embodiment has a configuration shown in a sectional view of FIG. 1. That is, the separator 1 for a battery of FIG. 1 includes a substrate 10 and porous heat resistance layers 11 disposed on surfaces of the substrate 10. In the sectional view of FIG. 1, a left-right direction (direction indicated by arrow W) represents a width direction of the separator 1 for a battery which is a rectangular film, and a vertical direction (direction indicated by arrow T) represents a thickness direction of the separator 1 for a battery. A longitudinal direction of the separator 1 for a battery is a direction perpendicular to the paper plane of FIG. 1.

The substrate 10 is a porous film formed of a polyolefin resin which is a thermoplastic resin. More specifically, a polyolefin resin having a relatively low melting point lower than 150° C. is used as the resin constituting the substrate 10. Specifically, polyethylene (PE) or polypropylene (PP) can be used. The substrate 10 may have a single-layer structure of PE or PP or have a three-layer structure (for example, PE/PP/PE). In this case, PE may be low-density polyethylene (LDPE) or high-density polyethylene (HDPE).

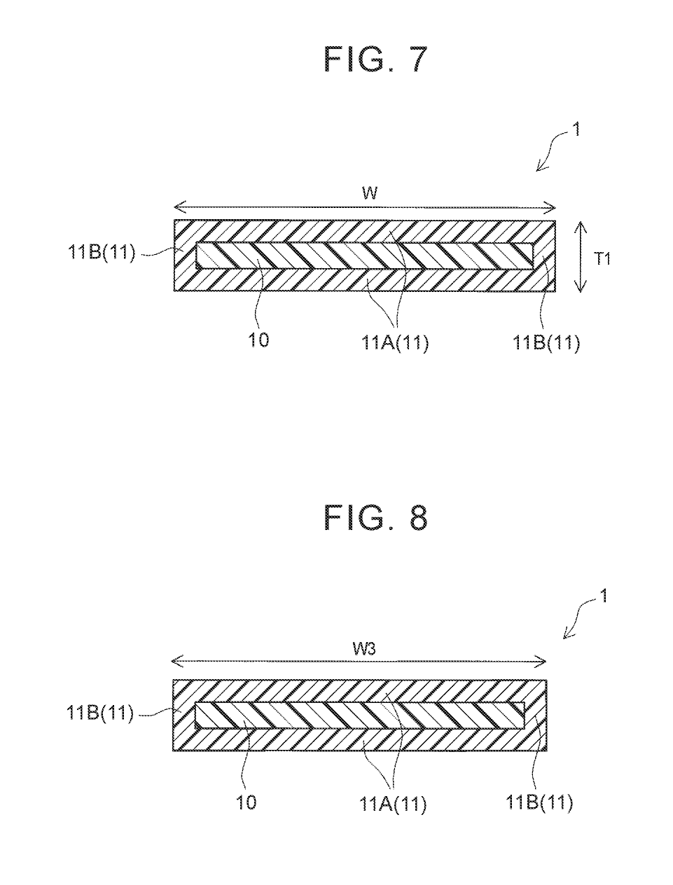

The porous heat resistance layers 11 include inorganic filler particles and a binder which are porous. The inorganic filler particles are particles of alumina, silica, boehmite, magnesia, titania, or the like. Through the binder, the inorganic filler particles are adhered to each other, or the inorganic filler particle and the substrate 10 are adhered to each other. The binder is a resin such as an acrylic resin, polyvinylidene fluoride (PVDF), polyvinyl pyrrolidone (PVP), polyolefin, or styrene-butadiene rubber (SBR). The porous heat resistance layers 11 of the separator 1 for a battery according to the embodiment are formed not only on main surfaces of the substrate 10 but also on opposite end portions in the width direction. Hereinafter, the main surface portions of the porous heat resistance layers 11 will be referred to as “main surface portions 11A”, and the end portions of the porous heat resistance layers 11 will be referred to as “end portions 11B”. In FIG. 1, for easiness of visual recognition, the thicknesses of the main surface portions 11A are shown to be slightly larger than the actual dimensions (the same shall be applied to FIGS. 7 and 8).

In the separator 1 for a battery according to the embodiment, the thicknesses of the porous heat resistance layers 11 satisfy the following two conditions: 1. The thicknesses of the end portions 11B are in a range of 5 to 5000 μm; and 2. The thickness of each of the end portions 11B is equal to or more than the sum of thicknesses of the front and back main surface portions 11A. “The thickness of each of the end portions 11B” refers to not the sum of the thicknesses of the right and left end surfaces 11B but the thickness of either one of the end portions 11B. The thickness direction of “the thickness of each of the end portions 11B” is the width direction of the separator 1 for a battery, that is, the left-right direction (direction indicated by arrow W) in the sectional view of FIG. 1. On the other hand, the thickness direction of “the thicknesses of the front and back main surface portions 11A” is the vertical direction (direction indicated by arrow T) in the sectional view of FIG. 1.

The separator 1 for a battery according to the embodiment having the above-described configuration is manufactured as follows. As materials for manufacturing the separator 1 for a battery according to the embodiment, a resin film for forming the substrate 10 and a slurry for forming the porous heat resistance layers 11 are prepared. The resin film is the above-described substrate 10. The slurry is a fluid in which the inorganic filler particles are kneaded with the binder. In this case, the proportion of the binder in the slurry is adjusted such that gaps between the inorganic filler particles in the porous heat resistance layers 11 having undergone drying described below are not completely filled with the binder resin.

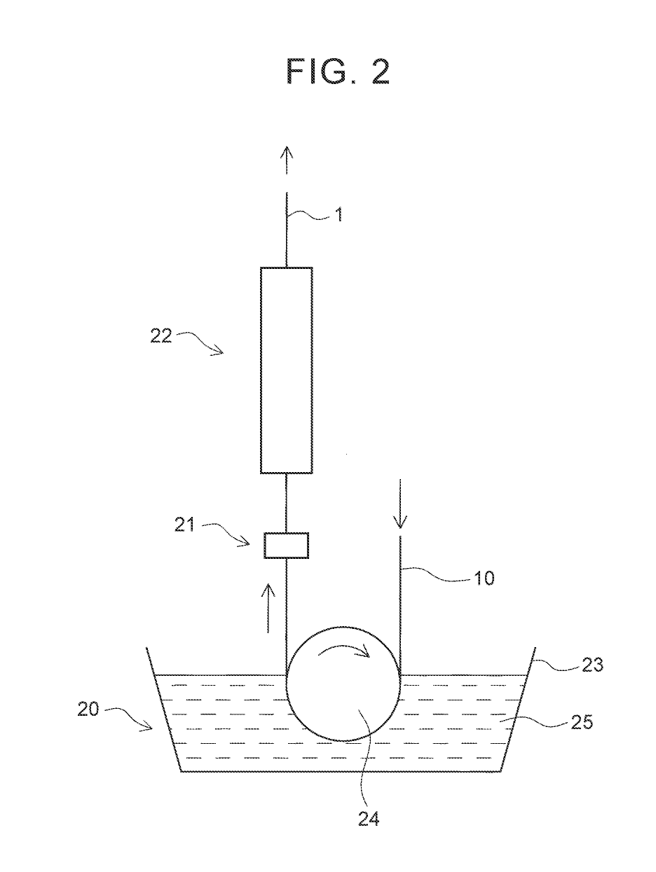

As shown in FIG. 2, an apparatus which is used to manufacture the separator 1 for a battery according to the embodiment includes an applying portion 20, a thickness adjusting portion 21, and a drying portion 22. The applying portion 20 includes a pan 23 and a roller 24. The pan 23 contains the above-described slurry 25, and a part of the roller 24 is dipped in the slurry 25. As a result, when the resin film (substrate) 10 supplied to the roller 24 is U-turned, the resin film contacts the slurry 25. The resin film 10 which is turned back by the roller 24 moves upward in a state where the slurry 25 is applied to the front and back surfaces and the opposite end portions. That is, in the applying portion 20, an application step of applying the slurry 25 to the front and back surfaces of the resin film as the substrate 10 and to the opposite end portions thereof in the width direction.

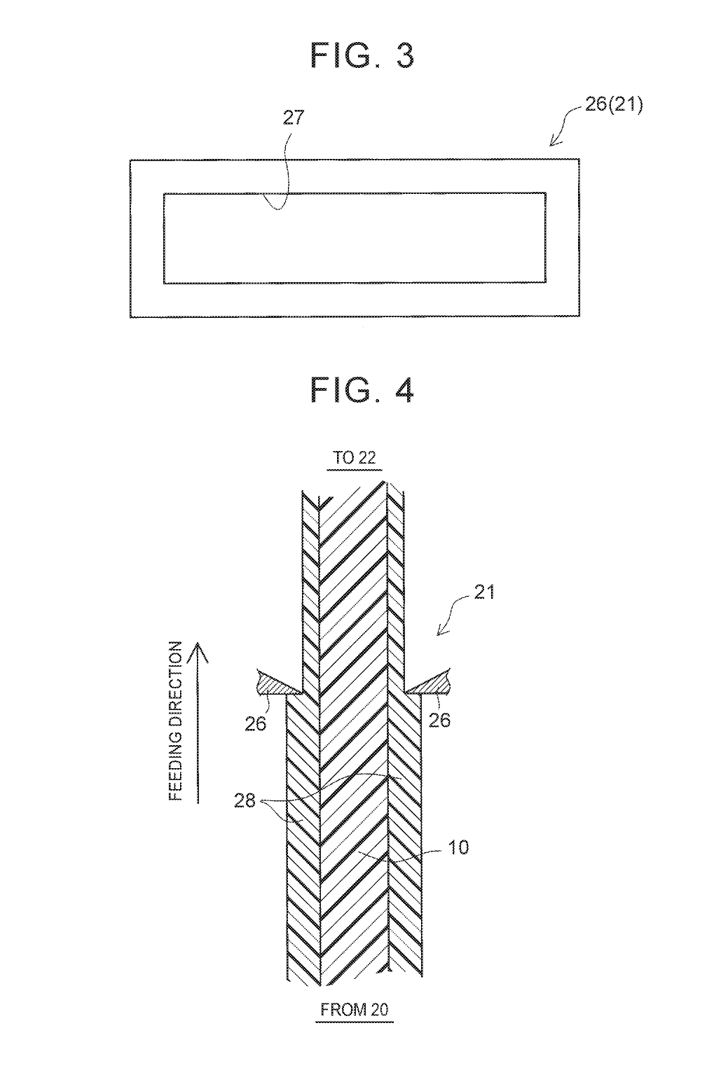

In the thickness adjusting portion 21, a gap member 26 shown in FIG. 3 is disposed. In the gap member 26, an opening 27 having an elongated rectangular shape is formed. The horizontal and vertical dimensions of the opening 27 are slightly larger than the thickness and width of the resin film as the substrate 10. By allowing the resin film (substrate) 10, which has been passed through the applying portion 20, to pass through the opening 27 of the gap member 26, surplus portions of the slurry layers 28 disposed on the resin film 10 are removed. As a result, the thickness of each of the slurry layers 28 disposed on the resin film 10 is adjusted. The sectional view of FIG. 4 shows adjustment of the thickness of each of the slurry layers 28 using the gap member 26. FIG. 4 shows a state where the thickness of each of the slurry layers 28 disposed on the front and back surfaces of the resin film 10 is adjusted along a feeding direction of the resin film 10 (direction indicated by an arrow in FIG. 4). The thickness of each of the slurry layers 28 disposed on the opposite end portions in the width direction is adjusted by the gap member 26. That is, in the thickness adjusting portion 21, regarding the resin film 10 which has passed through the applying portion 20, a thickness adjustment step of adjusting the thickness of each of the slurry layers 28 disposed on the front and back surfaces and to the opposite end portions in the width direction is performed. The horizontal and vertical dimensions of the opening 27 are determined such that the thicknesses of the porous heat resistance layers 11 which are measured after drying described below is adjusted to a desired value.

In the drying portion 22, the resin film (substrate) 10 which has passed through the thickness adjusting portion 21 is appropriately heated such that volatile components in the slurry layers 28 are removed. As a result, the slurry layers 28 on the substrate 10 form the porous heat resistance layers 11. That is, in the drying portion 22, a drying step of drying the slurry layers 28 on the substrate 10 to form the porous heat resistance layers 11 is performed. In this way, the separator 1 for a battery according to the embodiment is manufactured.

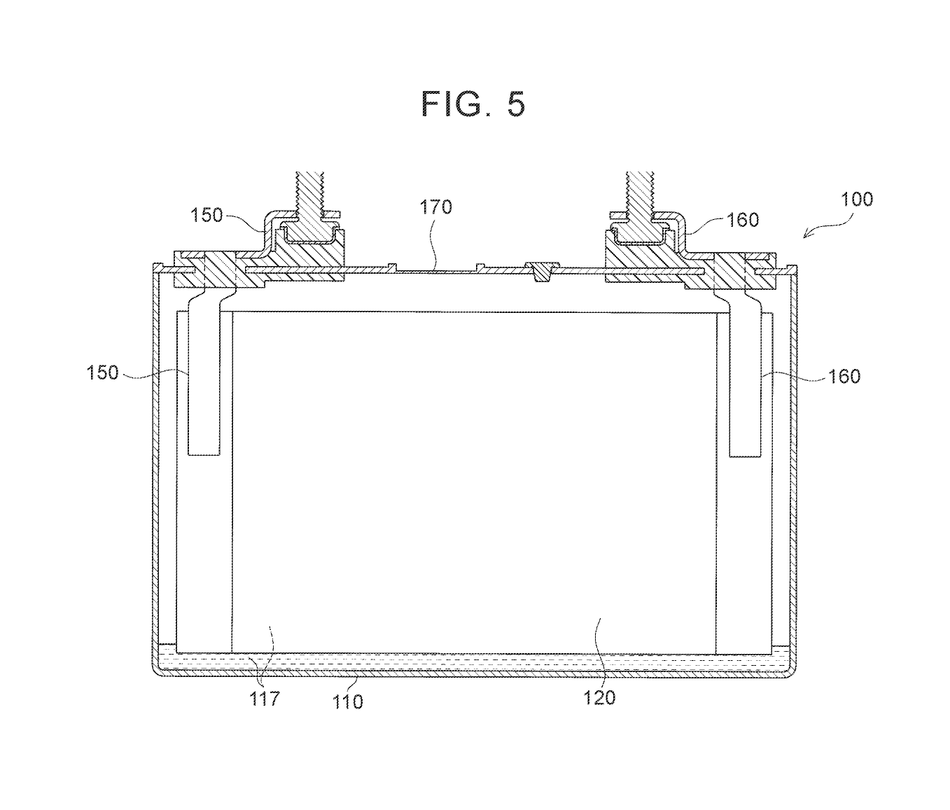

The separator 1 for a battery according to the embodiment is used as a component of a battery. Specifically, the separator 1 for a battery is laminated together with a positive electrode sheet and a negative electrode sheet of the battery to form an electrode body. As shown in FIG. 5, the electrode body 120 is sealed in an external body 110 together with an electrolytic solution 117 to form a battery 100. The battery 100 includes a positive electrode external terminal 150 and a negative electrode external terminal 160. Further, a safety valve 170 is provided.

The operation of the separator 1 for a battery in the battery 100 is as follows. First, in a normal status of the battery 100, the separator 1 for a battery in the electrode body 120 is dipped in the electrolytic solution, the movement of ions between the positive electrode sheet and the negative electrode sheet is allowed, and direct contact between both of the electrode sheets is prevented. This function is an original function of a separator. When the internal temperature of the battery 100 increases due to an overcurrent or the like and reaches a melting point of the resin constituting the substrate 10, the substrate 10 is melted. As a result, a shutdown function is exhibited, and a current path is disconnected.

In the separator 1 for a battery according to the embodiment, excessive shrinkage of the substrate 10 during shutdown is prevented. That is, the polyolefin resin constituting the substrate 10 is likely to shrink during melting. In particular, in a state where the resin constituting the substrate 10 has a low melting point, the degree of thermal shrinkage during melting is likely to large. This excessive shrinkage of the substrate 10 is prevented in the separator 1 for a battery according to the embodiment.

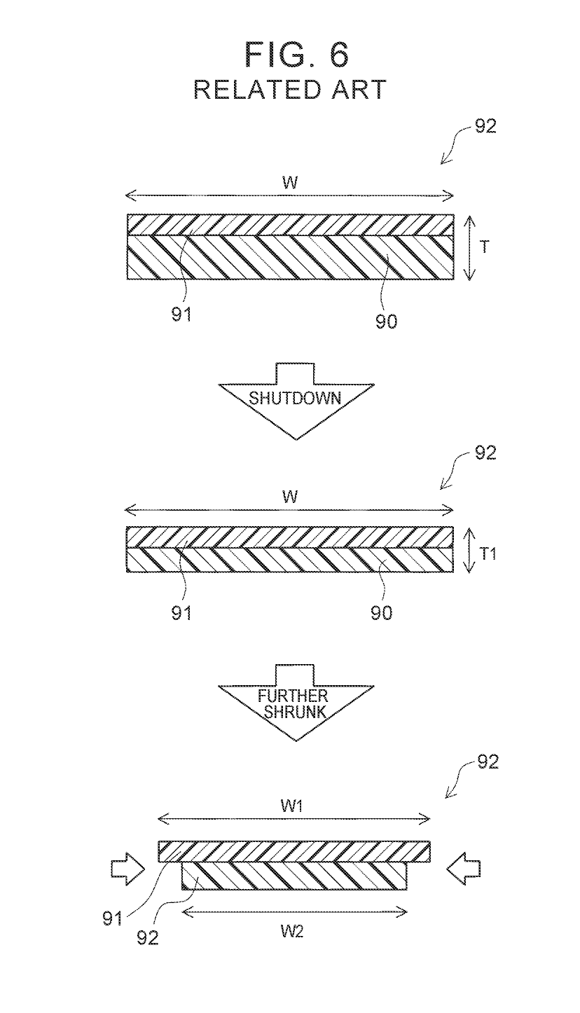

For the description of the above operation, a state where thermal shrinkage occurs in a separator for a battery of the related art will be described using FIG. 6. In a separator 92 for a battery in which a heat resistance layer 91 is present only on a single surface of a substrate 90 as shown in the upper portion of FIG. 6 (which is a sectional view in the width direction as in FIG. 1), the substrate 90 shrinks in a thickness direction due to shutdown as shown in the middle portion of FIG. 6. Therefore, a thickness T1 of the separator 92 for a battery after shutdown is less than a thickness T thereof before shutdown. On the other hand, a width W of the separator 92 for a battery does not substantially shrinkage due to shutdown. Due to the effect of the heat resistance layer 91, the width W of the separator 92 for a battery is retained after shutdown. The heat resistance layer 91 formed of an inorganic material does not shrink at a temperature at which the substrate 90 shrinks, and the size thereof during cooling is retained. Therefore, due to the presence of the heat resistance layer 91, the substrate 90 can shrink only in the thickness direction without shrinking in an in-plane direction.

However, the above result is limited to only a case where the degree of shrinkage of the substrate 90 is not that strong. In a case where the degree of shrinkage of the substrate 90 is strong, as shown in the lower portion of FIG. 6, even the presence of the heat resistance layer 91 cannot prevent the shrinkage of the substrate 90 in the width direction. Since the heat resistance layer 91 is an aggregate of particles, there is a limit in resisting shrinkage stress of the substrate 90. Therefore, as shown in the lower portion of FIG. 6, the width W1 of the separator 92 for a battery is less than the original width W. The width W2 of the substrate 90 in this state is further less than the width W1.

On the other hand, in the battery 100 in which the separator 1 for a battery is used, the status shown in the lower portion of FIG. 6 does not occur. This is because the dimension retaining function of the porous heat resistance layers 11 are effectively exhibited. FIG. 7 is a sectional view showing a state where shutdown occurs in the separator 1 for a battery according to the embodiment. In the state of FIG. 7, as in the middle portion of FIG. 6, the width W of the separator 1 for a battery is retained substantially as it is, and only the thickness T1 decreases. Until this stage, there is no significant difference from the separator 92 for a battery.

However, in a stage where the temperature of the battery 100 further increases and the porous heat resistance layers 11 strongly shrink, there is a difference in the state shown in the lower portion of FIG. 6. That is, as shown in FIG. 8, even in this stage, the separator 1 for a battery does not substantially change from the state of FIG. 7. More specifically, in the stage of FIG. 8, the width W3 of the separator 1 for a battery is slightly less than the original width W. However, there is only little difference between the width W3 and the width W1 shown in the lower portion of FIG. 6. Regarding the substrate in the separator 1 for a battery, unlike the lower portion of FIG. 6 in which the substrate 90 peels off from a part of the heat resistance layer 91, a state where the substrate 10 is present over the entire width of the porous heat resistance layers 11 excluding the end portions 11B. Accordingly, even in the above-described stage, the separator 1 for a battery maintains a sufficient shutdown effect.

The reason why the separator 1 for a battery according to the embodiment can maintain the shutdown effect even in the state of FIG. 8 is the presence of the porous heat resistance layers 11. Specifically, the reason is that the porous heat resistance layers 11 are present not only on the front and back surfaces (main surface portions 11A) of the substrate 10 but also on the opposite end portions of the substrate 10 in the width direction (end portions 11B). Therefore, the substrate 10 of the separator 1 for a battery are supported from all of the four sides by the main surface portions 11A and the end portions 11B of the porous heat resistance layers 11. Thus, the substrate 10 does not substantially shrink even in the state of FIG. 8 where a substrate of the related art strongly shrinks. In particular, the reason for this is that the substrate 10 is fixed to the opposite sides even in the width direction due to the presence of the end portions 11B. This is because the opposite ends in the width direction are the origin points where the shrinkage of the substrate 10 starts.

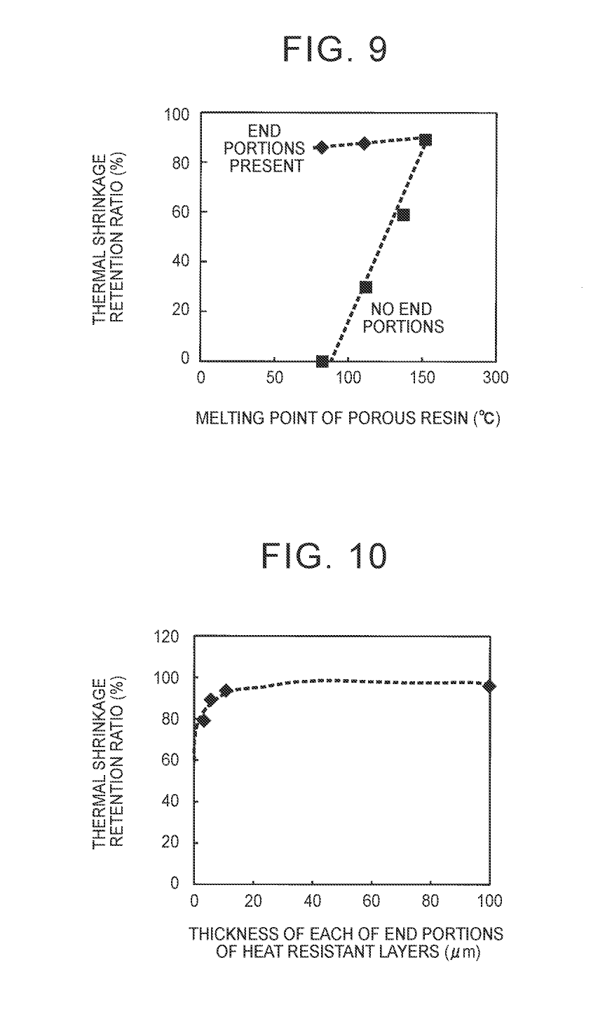

The effect of preventing the shrinkage of the substrate 10 obtained by the above-described disposition of the porous heat resistance layers 11 is particularly significant in a case where a thermoplastic resin used has a relatively low melting point as in the case of the substrate 10 in the embodiment. This point will be described using a graph of FIG. 9. In the graph of FIG. 9, the horizontal axis represents the melting point of the porous polyolefin resin used as the substrate 10. The vertical axis represents a retention ratio of the size of the substrate 10 (or 90) in the width direction to the original width in the state of the lower portion of FIG. 6 (no end portions) or the state of FIG. 8 (end portions present). That is, in regard to “No End Portions”, the retention ratio is a value obtained by dividing W2 in the lower portion of FIG. 6 by the W of the upper portion of FIG. 6. In regard to “End Portions Present”, the retention ratio is a value obtained by dividing the size of a net portion, which is obtained by subtracting the size of the end portions 11B from the W3 of FIG. 8, by the size of a net portion which is obtained by subtracting the size of the end portions 11B from the W of FIG. 1. Here, in regard to “End Portions Present”, a case where the thickness of each of the end portions 11B is 5 μm will be described as an example.

In FIG. 9, in a case where the resin has a relatively high melting point of 150° C., both of “End Portions Present” and “No End Portions” show a high retention ratio without a difference. However, in a case where the melting point is further lower, the retention ratio significantly decreases in “No End Portions”. On the other hand, in “End Portions Present”, even in a case where the melting point is lower than 150° C., the retention ratio does not substantially decrease. That is, in a case where the melting point is low as described above, the providing of the end portions 11B is technically significant. The melting point of the resin used in the separator 1 for a battery according to the embodiment is in a range in which the technical significance of the end portions 11B is large.

Next, an appropriate range of the thicknesses of the end portions 11B will be described using a graph of FIG. 10. In the graph of FIG. 10, the horizontal axis represents the thickness of each of the end portions 11B. The vertical axis represents the same as “End Portions Present” represented by the vertical axis in the graph of FIG. 9. Here, a case where the melting point of the resin of the substrate 10 is 135° C. will be described as an example.

It can be seen from FIG. 10 that: in a case where the thickness of each of the end portions 11B is substantially zero, the retention ratio is low; and in a case where the thickness of each of the end portions 11B is 5 μm or more, the retention ratio is 80% or higher. As a result, it is presumed that the necessary lower limit of the thickness of each of the end portions 11B is 5 μm. In a case where the thickness of each of the end portions 11B is larger than the lower limit, a high retention ratio is stably obtained. As a result, the thickness is shown up to 100 μm in FIG. 10, but it can be said that the upper limit of the thickness of each of the end portions 11B is not particularly limited from the viewpoint of the retention ratio.

However, when the end portions 11B are excessively thick, the shutdown effect is actually insufficient. The reason for this is that the thermoplastic resin of the substrate 10 is not present in the end portions 11B. Therefore, even during shutdown, gaps between the inorganic filler particles of the end portions 11B are not blocked, and a current path remains. Therefore, the shutdown effect is insufficient. From this point of view, the upper limit of the thickness of each of the end portions 11B is limited. In a case where the thickness of each of the end portions 11B is more than 5000 μm which is outside of the range shown in FIG. 10, the effect of a current path remaining after shutdown is not negligible, and the shutdown effect is insufficient.

It is necessary that the thickness of each of the end portions 11B is equal to or more than the sum of the thicknesses of the main surface portions 11A of the porous heat resistance layers 11. As a result, a sufficient shutdown function for efficiently preventing thermal shrinkage of the substrate 10 over the entire region of the separator 1 for a battery can be obtained.

Hereinafter, Examples and Comparative Examples will be described. In each of Examples and Comparative Examples, using a method described below, a positive electrode sheet, a negative electrode sheet, and a separator (the separator 1 for a battery or the separator 92 for a battery) were prepared, a battery was prepared, and a test was performed. First, features common to Examples and Comparative Examples will be described.

[Positive Electrode Sheet]

The positive electrode sheet was prepared under the following conditions.

### Solid Components of Active Material Layer:

Active material: 90 parts by weight of a layered oxide containing lithium, nickel, manganese, and cobalt

Conductive material: 8 parts by weight of carbon black (acetylene black powder)

Binder: 2 parts by weight of PVDF

Solvent kneaded during application of the active material layer: N-methyl-2-pyrrolidone (NMP)

Current collector foil: aluminum foil having a thickness of 20 μm
Coating weight during application: 15 mg/cm²

[Negative Electrode Sheet]

The negative electrode sheet was prepared under the following conditions.

### Solid Components of Active Material Layer:

Active material: 98 parts by weight of natural graphite

Binder: 1 part by weight of SBR

Thickener: 1 part by weight of carboxymethyl cellulose (CMC)

Solvent kneaded during application of the active material layer: water

Current collector foil: copper foil having a thickness of 10 μm
Coating weight during application: 15 mg/cm²

[Separator]

The separator was prepared under the following conditions. The melting point of a base resin and the thickness of each of end portions of a heat resistance layer were changed as described below in each of Examples and Comparative Examples.

### Substrate (Porous Film)

Kind of resin: PE was selected among polyolefin resins

Width: 120 mm

Thickness: 20 μm

### Heat Resistance Layer

Kind of inorganic filler particle: alumina was selected among the above-described examples

Kind of binder: an acrylic binder was selected among the above-described examples

Thicknesses of main surface portions: 2 μm per surface

Drying Conditions after application: 60° C. and 5 minutes

[Battery Configuration]

Conditions were as follows.
Electrode body: flat wound electrode body

### Electrolytic Solution:

Solvent: nonaqueous mixed solution of ethylene carbonate, ethyl methyl carbonate, and diethyl carbonate (mixing ratio: 3:5:2 by volume)

Electrolyte: lithium hexafluorophosphate (LiPF₆) (concentration: 1 M)

### Battery Case:

Type: a flat square hard case shown in FIG. 5 equipped with a safety valve

Size: a length of 75 mm, a width of 120 mm, a depth of 15 mm, a case thickness of 1 mm

Theoretical capacity: 5 Ah

[Finishing]

The prepared battery was charged to 4.2 V at a constant current of 5 A (corresponding to a rate of 1 C) at an environment temperature of 25° C., and the operation was stopped for 5 minutes. Next, the battery was discharged to 3.0 V. Next, the operation was stopped for 5 minutes, and then the initial capacity was verified by performing CC-CV charging (4.1 V, rate: 1 C, 0.01 C-cut off) and CC-CV discharging (3.0 V, rate: 1 C, 0.01 C-cut off).

The melting point of the base resin and the details of the heat resistance layer in each of Examples and Comparative Examples are as shown in Table 1. The melting point of the base resin in each of Examples was 80 to 135° C. In Table 1, the item “Thickness of Each of End Portions” shows a thickness value of each of the end portions of the heat resistance layers. In each of Examples of Table 1, the thickness of each of the end portions is the lower limit value or higher and is equal to or more than the sum of the thicknesses of the main surface portions.

TABLE 1

| | | Thickness | Position where Heat | Melting Point |
|---|---|---|---|---|
| | | of Each | Resistance Layers were | (° C.) of Base |
| | | of End Portions | Present | Resin |
| Examples | 1 | 5 | Main Surfaces and | 135 |
| | 2 | 10 | Opposite End Portions | |
| | 3 | 100 | | |
| | 4 | 1000 | | |
| | 5 | 2000 | | |
| | 6 | 5000 | | |
| | 7 | 5 | | 110 |
| | 8 | | | 80 |
| Comparative | 1 | None | Only Main Surfaces | 135 |
| Examples | 2 | 3 | Main Surfaces and | |
| | | | Opposite End Portions | |
| | 3 | 5 | Only Opposite End | |
| | | | Portions | |
| | 4 | None | Only Main Surfaces | 110 |
| | 5 | | | 80 |
| | 6 | | | 150 |
| | 7 | 5 | Main Surfaces and | |
| | | | Opposite End Portions | |

Among the items according to Comparative Examples in Table 1, an item represented by italic font did not satisfy the preferable conditions of the present disclosure or was outside of the range where the technical significance of the present disclosure is exhibited. That is, Comparative Examples 1 and 4 to 6 did not satisfy the preferable conditions of the present disclosure, in that the viewpoint that the opposite end portions of the heat resistance layers were not provided. Comparative Example 2 did not satisfy the preferable conditions of the present disclosure, in that: the opposite end portions of the heat resistance layers were provided but the thickness of each of the opposite end portions was insufficient. The thickness of each of the opposite end portions was less than the sum of the thicknesses of the main surface portions. Comparative Example 3 did not satisfy the preferable conditions of the present disclosure, in that only the opposite end portions were provided without providing the main surface portions of the heat resistance layers. In Comparative Examples 6 and 7, the base resin had a high melting point, and the technical significance of the present disclosure was not exhibited.

Regarding each of Examples and Comparative Examples, the retention ratio during thermal shrinkage was measured, and an overcharge test was performed.

[Measurement of Retention Ratio During Thermal Shrinkage]

A shrinkage test was performed at 200° C. which was higher than the melting point of the resin used in each of Examples and Comparative Examples. This test was performed by using not the battery but the separator alone. Specifically, the separator was cut into a size of 50 mm×50 mm and was fixed to a glass plate through KAPTON tape (“KAPTON”, registered trade name) to prepare a specimen. This specimen was temporarily heated to 200° C., and then the length L of the most shrunk portion was measured. The retention ratio (%) was calculated from (L/50)×100. A specimen where the calculated retention ratio was 85% or higher was evaluated as “Pass” and a specimen where the calculated retention ratio was lower than 85% was evaluated as “Fail”.

[Overcharge Test]

In this test, a specimen in the form of a battery was used. A state where the battery was charged to 4.2 V was a starting condition, and the battery was further charged at a charge current of 10 C at an environment temperature of 25° C. At this time, “Pass” or “Fail” was determined based on whether the surface temperature of the battery reached 150° C. (Fail) or not (Pass).

TABLE 2

| | | Thermal Shrinkage | Overcharge |
|---|---|---|---|
| | | Retention Ratio (%) | Test |
| Examples | 1 | 90 | Pass |
| | 2 | 95 | |
| | 3 | 98 | |
| | 4 | 100 | |
| | 5 | | |
| | 6 | | |
| | 7 | 88 | |
| | 8 | 86 | |
| Comparative | 1 | 60 | Fail |
| Examples | 2 | 80 | |
| | 3 | 50 | |
| | 4 | 30 | |
| | 5 | 0 | |
| | 6 | 90 | Pass |
| | 7 | | |

The test results are as shown in Table 2. In table 2, an item evaluated as “Fail” was represented by italic font. In Table 2, the results of all of the Examples were satisfactory. In particular, in Examples 4 to 6 in which the end portions of the heat resistance layers were formed to be thick, the retention ratio was 100%, which was satisfactory. It can be said that the results of Examples 4 to 6 were more satisfactory than the results of Comparative Examples 6 and 7 in which the melting point of the base resin was high. In Examples 7 and 8, the melting point of the base resin was considerably low but was still in the acceptable range.

On the other hand, in Comparative Examples 1 to 5 in which the conditions for forming the heat resistance layers were not preferable, all the results were evaluated as “Fail”. In particular, in Comparative Example 3 in which the main surface portions of the heat resistance layers were not provided and Comparative Examples 4 and 5 in which the end portions of the heat resistance layers were not provided and in which the melting point of the base resin was considerably low, the retention ratio was extremely low. In Comparative Example 2 in which the main surface portions and the end portions of the heat resistance layers were formed but the thickness of each of the end portions was insufficient, the retention ratio was close to the range of “Pass”, and the result of the overcharge test was evaluated as “Fail”. In Comparative Examples 6 and 7, the test results were evaluated as “Pass”, which were outside of the application range of the present disclosure.

The following can be seen from a comparison between Example 1 and Comparative Example 3. That is, the formation of the end portions of the heat resistance layers was an advantageous feature but was not enough to obtain a sufficient effect of preventing thermal shrinkage. By forming the heat resistance layers on the front and back surfaces and the opposite end portions as in Example 1, a sufficient effect of preventing thermal shrinkage can be obtained.

As described above in detail, according to the embodiment and Examples, the separator 1 for a battery was used in which the porous film formed of a polyolefin resin was used as the substrate 10 and in which the porous heat resistance layers 11 (the main surface portions 11A and the end portions 11B) are provided on the front and back surfaces of the substrate 10 and on the opposite end portions of the substrate 10 in the width direction. The thickness of each of the end portions 11B is in a range of 5 to 5000 μm and is equal to or more than the sum of the thicknesses of both of the main surface portions 11A. As a result, even in a state where the resin constituting the substrate 10 is melted due to an increase in the battery temperature, the shrinkage of the substrate 10 is efficiently prevented. The size of the separator 1 for a battery in the width direction is retained substantially as it is. As a result, even in a case where the melting point of the base resin is relatively low, a sufficient shutdown function can be obtained in the separator 1 for a battery.

The embodiment and Examples are merely exemplary and does not limit the present disclosure. Accordingly, the present disclosure can be improved and modified in various ways within a range not departing from the scope of the present disclosure. For example, in the manufacturing process of the separator 1 for a battery, the apparatus shown in FIG. 2 is not necessarily used, and another process element having the same function may be used.

What is claimed is:

1. A separator for a battery, the separator comprising:
a substrate that is a porous film made of a polyolefin resin and has a melting point lower than 150° C.; and
porous heat resistance layers that are disposed on front and back surfaces of the substrate and on opposite end portions of the substrate in a width direction and include inorganic filler particles and a binder, wherein
a thickness of each of the porous heat resistance layers disposed on the opposite end portions of the substrate in the width direction is in a range of 5 to 5000 μm and is equal to or more than a sum of thicknesses of the porous heat resistance layers disposed on the front and back surfaces of the substrate.

2. The separator according to claim 1, wherein
the melting point of the substrate is in a range of 80 to 135° C.

3. A secondary battery comprising:
a positive electrode sheet;
a negative electrode sheet; and
the separator according to claim 1 that is laminated together with the positive electrode sheet and the negative electrode sheet.

4. A method of manufacturing a separator for a battery, the method comprising:
forming a slurry layers by applying a slurry including inorganic filler particles and a binder to front and back surfaces of a substrate and to opposite end portions of the substrate in a width direction, the substrate being a porous film formed of a polyolefin resin and having a melting point lower than 150° C.;
adjusting thicknesses of the slurry layers formed on the front and back surfaces of the substrate and on the opposite end portions of the substrate in the width direction such that, when measured after drying, a thickness of each of the slurry layers disposed on the opposite end portions of the substrate in the width direction is in a range of 5 to 5000 μm and is equal to or more than a sum of thicknesses of the slurry layers disposed on the front and back surfaces of the substrate; and
drying the slurry layers whose thicknesses are adjusted.

5. The method according to claim 4, wherein
the thicknesses of the slurry layers disposed on the front and back surfaces of the substrate and on the opposite end portions of the substrate in the width direction are adjusted by allowing the substrate to pass through a rectangular opening.
